(19) United States
(12) Patent Application Publication
(10) Pub. No.: US 2011/0202772 A1
(43) Pub. Date: Aug. 18, 2011

(54) NETWORKED COMPUTER IDENTITY ENCRYPTION AND VERIFICATION

(75) Inventors: Lior Frenkel, Misgav Dov (IL); Amir Zilberstein, Yad Rambam (IL)

(73) Assignee: HUMAN INTERFACE SECURITY LTD., Rosh HaAyin (IL)

(21) Appl. No.: 13/124,661

(22) PCT Filed: Oct. 15, 2009
(86) PCT No.: PCT/IB09/54541

§ 371 Date: Apr. 17, 2011

(30) Foreign Application Priority Data
Oct. 27, 2008 (IL) 194943

(51) Int. Cl. H04L 9/32; G06F 21/00

(52) U.S. Cl. 713/176

(57) ABSTRACT

A method for communication includes initiating a communication session over a network between a remote computer (24) and a local computer (20), which has a central processing unit (CPU) (40) and an input device (30). A record is stored at the remote computer of an identification code that is associated with the input device of the local computer and is inaccessible to the CPU. When data input by a user to the local computer is received via the input device, a cryptographic signature over the data and the identification code is generated at the local computer using a processor (46) other than the CPU. The signature is transmitted to the remote computer and is decrypted at the remote computer in order to authenticate the data.

### FIELD OF THE INVENTION

The present invention relates generally to information security, and specifically to devices and methods for enhancing the security of data communications.

### BACKGROUND OF THE INVENTION

Data encryption is widely used in preventing unauthorized access to data. Various methods of data encryption are known in the art. In general, these methods use a key to convert data to a form that is unintelligible to a reader (human or machine), and require an appropriate key in order to decrypt the data. Symmetric encryption methods use the same key for both encryption and decryption. Such symmetric methods include the well-known DES (Data Encryption Standard) and AES (Advanced Encryption Standard) algorithms. In asymmetric encryption methods, such as the RSA (Rivest Shamir Adelman) algorithm, a computer that is to receive encrypted data generates complementary public and private keys and transmits the public key to the sender. After the sender has encrypted the data using the public key, only the holder of the private key can decrypt it.

Transport Layer Security (TLS), also known as Secure Sockets Layer (SSL), is a cryptographic protocol that provides secure communications on the Internet for applications such as web browsing and other data transfers. A client and server negotiate a TLS connection using a handshaking procedure in which the server sends its identification to the client in the form of a digital certificate, including the server's public encryption key. The client encrypts a random number using the server's public key and sends the result to the server, which decrypts the result using its private key. This random number is then used in generating keys for encryption and decryption over the secured connection between the client and server.

Even when secured communications are used for data transmission between computers, hackers have still found ways to intercept and use secret client information inside the computer. For instance, a malicious party who gains access to the memory of a computer (using a “Trojan horse” or other “spyware” program, for example) may be able to intercept messages in the computer and extract or otherwise tamper with secret message contents, such as usernames, passwords and credit card details. As another example, the malicious party may use a key-logger to copy and transmit a record of keystrokes made on the computer keyboard.

“Man-in-the-Browser” attacks use a particularly insidious type of malicious program, which interjects itself between the user and the browser. The man-in-the-browser program typically takes the form of a trusted browser extension, a DLL (dynamically linked library), or a browser helper object. It modifies the data passing between the user (via the computer input and output devices) and the browser's security mechanism without any user-observable symptoms. Thus, for example, while the user is performing a transfer of funds over a secure connection with the Web site of his bank, the man-in-the-browser program may alter the amount and/or target account of the transfer. From both the bank's and the user's points of view, the transaction is taking place normally, over a secure connection, with expected client/server interactions (but with very different results from those intended by the user). Because of this apparent normalcy, fraudulent transactions using man-in-the-browser programs are very difficult to detect until after the fact.

### SUMMARY OF THE INVENTION

An embodiment of the present invention provides a method for communication, which includes initiating a communication session over a network between a remote computer and a local computer, which has a central processing unit (CPU) and an input device. A record is stored at the remote computer of an identification code that is associated with the input device of the local computer and is inaccessible to the CPU. Upon receiving data input by a user to the local computer via the input device, a cryptographic signature is generated at the local computer over the data and the identification code using a processor other than the CPU. The signature is transmitted to the remote computer, which decrypts the signature in order to authenticate the data.

There is also provided, in accordance with an embodiment of the present invention, apparatus for use in a communication session over a network between a remote computer and a local computer, which has a central processing unit (CPU). The apparatus includes an input device comprising an input transducer, for receiving data input by a user to the local computer. A processor, is coupled to the input transducer and is configured to generate, using an identification code that is recorded by the remote computer and is inaccessible to the CPU, a cryptographic signature over the data and the identification code for transmission of the signature to the remote computer, wherein the signature is decryptable by the remote computer in order to authenticate the data.

The present invention will be more fully understood from the following detailed description of the embodiments thereof, taken together with the drawings in which:

### BRIEF DESCRIPTION OF THE DRAWINGS

FIG. 1 is a schematic pictorial illustration of a system for secure data communications, in accordance with an embodiment of the present invention;

FIG. 2 is a block diagram that schematically shows functional components of an input device for secure data communications, in accordance with an embodiment of the present invention;

FIG. 3 is a schematic pictorial illustration showing physical and logical communication paths in a secure communication system, in accordance with an embodiment of the present invention;

FIG. 4 is a flow chart that schematically illustrates a method for secure data transmission, in accordance with an embodiment of the present invention; and

FIG. 5 is a flow chart that schematically illustrates a method for secure data transmission, in accordance with another embodiment of the present invention.

### DETAILED DESCRIPTION OF EMBODIMENTS

### Overview

Embodiments of the present invention that are described hereinbelow provide improved methods and systems for protection of input data from tampering by malicious parties. In a disclosed embodiment, a user inputs data to a local computer using an input device, such as a keyboard. A communication session is established between the local computer and a remote computer, such as a server. An identification code, such as an embedded hardware code or session identifier, is associated with the input device and is known to the remote computer, but is inaccessible to the central processing unit (CPU) of the local computer.

In the course of the communication session, the user may input sensitive data via the input device for transmission to the remote computer. When the user inputs such data (in response to a prompt from the remote computer, for example), a processor other than the CPU generates a cryptographic signature over the data and the identification code of the input device. The signature is transmitted to the remote computer, which decrypts the signature in order to authenticate the data. The presence of the identification code in the signature enables the remote computer to verify that the data came directly from the input device and were not altered by malicious software, such as a man-in-the-browser program, running on the CPU. The term “signature,” in the context of the present patent application and in the claims, thus includes any sort of secure cryptographic result that is computed over the data and the code such that alteration of the data or the code would alter the signature.

The processor that generates the signature is typically coupled between the input transducer (such as the keys of the keyboard) and the CPU and runs embedded software that cannot be accessed or modified by hackers. In the embodiments that are shown in the figures that follow, this processor is embedded in a keyboard. In alternative embodiments, the processor may be embedded in other types of input devices or in an adapter coupled between an input device and the local computer console, or the processor may be physically contained in the console itself. Further alternatively, the CPU itself may be programmed in a manner that is resistant to hacking (using a hard-coded device driver, for example) to compute and transmit the cryptographic signatures.

The data that are input by the user may also be passed, in clear form, from the input device to the CPU for display on an output device, such as the local computer monitor screen. The user is thus able to see the data on screen, in the appropriate field in an on-line form, for example. If a malicious program running on the CPU attempts to alter the data, however, the signature will no longer match the data, and the malicious program will be unable to recalculate the signature because it does not have access to the identification code. Therefore, the server will be able to detect that the data have been tampered with and will reject the unauthenticated data.

### System Description

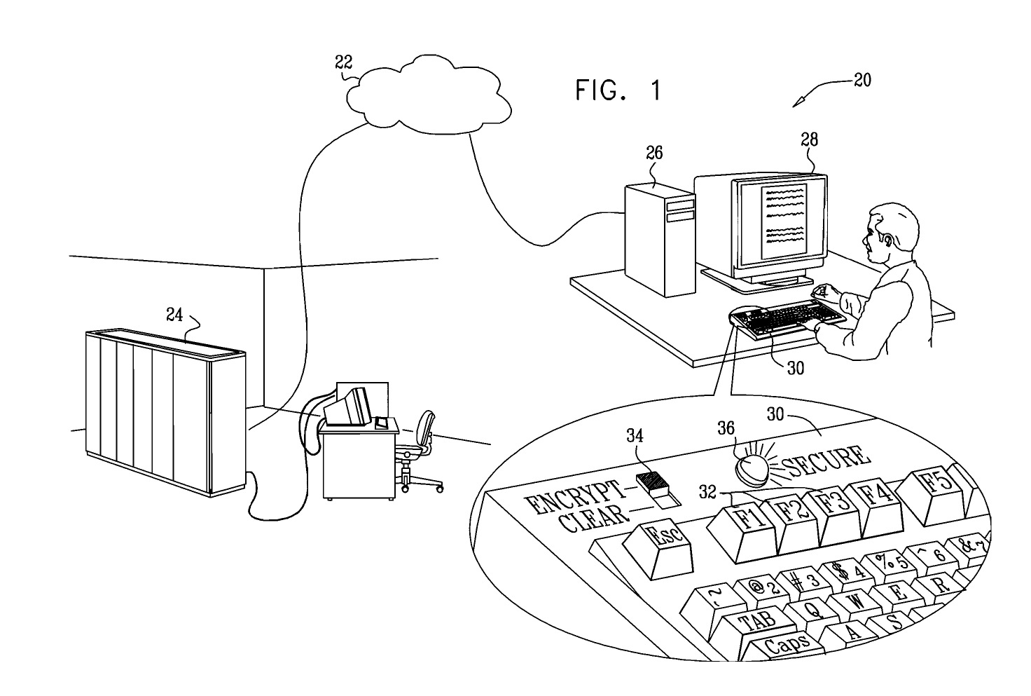

FIG. 1 is a schematic pictorial illustration of a system for secure data communications, in accordance with an embodiment of the present invention. In a typical scenario, a user operates a personal computer 20 to establish a communication session with a server 24 over a network 22, such as the Internet. Computer 20 comprises a console 26 with user interface components, including an output device, such as a video display screen 28, and an input device, such as a keyboard 30, which the user employs in the communication session. The keyboard has data security features that are used in computing cryptographic signatures over sensitive data and transmitting the signatures to server 24, as described in detail hereinbelow.

Personal computer 20 and server 24 are examples, respectively, of a local computer and a remote computer that may be used in this embodiment, but the principles of the present invention may similarly be implemented using any suitable types of computing devices that communicate over substantially any type of network. For example, the “local computer” may comprise a mobile telephone or personal digital assistant (PDA) with suitable computing and communication capabilities, while the network comprises a cellular network. Furthermore, the data security features associated with keyboard 30 may be implemented, mutatis mutandis, using other sorts of user input devices. Such input devices may comprise, for example, text, image capture and/or audio input transducers, such as a mouse or other pointing device, a camera, scanner or other imaging device, a microphone, or a touch-sensitive screen.

Keyboard 30 comprises keys 32, which serves as input transducers, and internal data security circuitry that is described hereinbelow. The keyboard typically has two modes of operation:
1. A secure mode, in which signals generated by strokes of keys 32 are cryptographically signed using an identification code that is not accessible to the CPU in console 26; and
2. A clear mode, in which the signature function of the keyboard is turned off or bypassed, so that the output data from the keyboard are not signed or otherwise secured, and the keyboard operates as a standard computer input device.
   In both modes, they keyboard output is intelligible to the console, typically in a standard keyboard data output format, and is typically echoed to screen 28 in the conventional manner.

A user-operable switch 34 permits the user to toggle between the two modes. The switch may simply be a manual switch on the keyboard package, as shown in FIG. 1, so that even if a hacker gains access to console 26 remotely (via network 22, for example), the hacker will be unable to change the switch setting. Alternatively, any other suitable type of switch that is known in the art may be used in this manner, including an electronic or logic-actuated switch, which may be actuated by a certain combination and/or sequence of user keystrokes on keys 32. Alternatively or additionally, in some embodiments the keyboard may switch modes automatically under the control of software or other suitable logic. Further alternatively, the keyboard may be configured to sign all data, in which case a mode switch is not required.

Optionally, a light-emitting diode (LED) 36 serves as an output transducer for indicating the current operating mode of keyboard 30. In this example, LED 36 lights to indicate that the keyboard is operating in secure mode. Alternatively, any other suitable type of output transducer may be used for this purpose, such as another type of lamp; an alphanumeric display, such as a liquid crystal display (LCD); another type of visual transducer such as a backlight, which causes a visible mode change in the input device; or even an audio transducer, which generates a sound to indicate the operating mode. The output transducer is typically controlled internally within the keyboard to prevent tampering by hackers.

In the figures and text that follow, certain security features relating to data authentication are described with reference to computer 20, keyboard 30, and the interaction of these elements with server 24. Alternatively or additionally, these features may be implemented using different sorts of input devices and in other system configurations. These features may also be used advantageously in conjunction with techniques of secure user authentication, as well as data encryption. Input devices and authentication techniques that may be used in this context are described, for example, in PCT patent application PCT/IL2008/001187, filed Sep. 3, 2008, which is assigned to the assignee of the present patent application and whose disclosure is incorporated herein by reference.

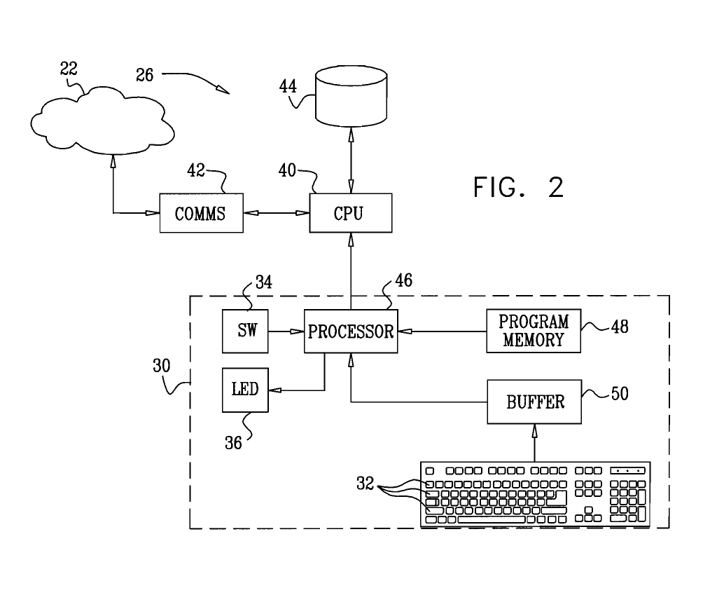

FIG. 2 is a block diagram that schematically shows details of console 26 and keyboard 30, in accordance with an embodiment of the present invention. Console 26 comprises a central processing unit (CPU) 40, which performs general computing functions. CPU 40 is coupled via a communication interface 42 to transmit and receive data to and from network 22. The console comprises a memory 44 (which may typically comprise both RAM and disk memory), which is accessed by the CPU in a conventional manner.

In scenarios that are known in the art, when computer 20 is to transmit data to server 24, even if the transmission itself is to be digitally signed or otherwise encrypted, the data are typically held in clear form in memory 44 at least temporarily in preparation for encryption. Any data signature (or other encryption function) is conventionally performed by CPU 40. As a result, if a malicious party is able to gain access to the CPU or memory through a software security breach, for example, that party may be able to alter the data before the CPU generates the signature. The CPU will then generate a signature that is apparently authentic over data that have been tampered with.

To avoid this sort of scenario in the present embodiment, an encryption processor 46 associated with keyboard 30 digitally signs data entered by the user via keys 32 when the secure mode is selected by switch 34. The encryption processor may comprise a programmable processing device, such as a microprocessor or field-programmable gate array (FPGA), or it may alternatively comprise a hard-coded logic device. Keys 32 generate respective data signals when depressed by the user, as is known in the art. These data signals are digitized and, optionally, held in a buffer 50. The digitized data signals are then signed by processor 46, using an appropriate encryption key and program instructions stored in a program memory 48. Processor 46 typically generates the signature over the data together with an identification code, which is not accessible to CPU 40. The identification code may, for example, comprise a unique hardware code, which is stored securely in memory 48 or in other media. Additionally or alternatively, the identification code may comprise a session code, which is transmitted over a secure connection from server 24 to processor 46, as described further hereinbelow.

Server 24 maintains a record of the identification code that is held by processor 46 and is thus able, upon receiving and processing the signatures transmitted by processor 46, to verify that the identification code was properly included in each signature. Normally, CPU 40 will possess neither the identification code nor the encryption key that is used by processor 46 to sign the data. Therefore, even though the secret data that are input to computer 20 by the user via keyboard 30 may themselves be accessible, in clear form, to CPU 40, and could thus be altered by a malicious program running on the computer, the malicious program will not be able to generate a new, valid signature over the altered data, and the server will reject any altered data as invalid.

In the embodiment shown in FIG. 2, encryption processor 46 is integrated with keyboard 30, typically within the keyboard package. Alternatively, the encryption processor may be packaged separately from the keyboard. For example, the encryption processor, along with switch 34, LED 36 and memory 48, may be packaged in a plug-in device (not shown in the figures), which has appropriate input and output connectors for coupling between a conventional keyboard and the keyboard input port of console 26. A device of this general design, for purposes of user authentication, is described in the above-mentioned PCT patent application and may be adapted to perform the secure signature functions described herein, in addition to or instead of the functions described in the PCT application. Functionally, the combination of a conventional keyboard with this sort of plug-in device constitutes an input device with equivalent capabilities to those of the integrated keyboard of FIGS. 1 and 2.

As a further alternative, the encryption processor may be contained inside console 26. The internal hardware configuration of the console may be such that input from the keyboard (or other input device) passes through the encryption processor before reaching the main memory and CPU. Alternatively or additionally, suitable software drivers may be used to route input data to the encryption processor for possible signature before permitting application software running on the CPU to access the data.

In normal operation of computer 20, the user maintains switch 34 in the clear position, so that data signatures are not generated by processor 46 when they are not required. From time to time, however, the user may toggle switch 34 to the secure mode, whereupon encryption processor 46 will output a suitable signature, in addition to the data, to CPU 40. The CPU in this case is unable to decipher the encrypted signature. Rather, the CPU stores the signature together with the data in memory 44 and/or transmits the signature and data via communication interface 42 to server 24 in accordance with instructions received by the CPU.

For example, in a secure communication session between computer 20 and server 24, the user of computer 20 may flip switch 34 to the secure mode position before inputting some particularly sensitive item of information, such as a dollar amount or target account number for a transfer of funds. Software running on computer 20 may cause CPU 40 to generate a data packet for transmission to computer 24, and to insert the data and signature that were generated by keyboard 30 into the payload of the packet before transmission. Server 24 holds the necessary key to decrypt the signature upon reception and thus to authenticate the payload data.

In an alternative embodiment, processor 46 may be configured to sign all data, generating a signature, for example, whenever the user presses the RETURN key. In this case, either the CPU or the server simply discards signatures that are not needed for data authentication. In this latter type of embodiment, switch 34 and LED 36 may be omitted from the keyboard.

In some embodiments, the server may transmit its public key to processor 46 for use in signing data input via keyboard 30. Only the server has the complementary private key that is needed to decrypt the signature. Thus, even if a malicious party gains access to the server's public key, that party will not be able to decrypt the signature in order to discover the identification code and thus will be unable to generate valid signatures over altered data even using the public key.

Some embodiments of the present invention use the Secure Socket Layer (SSL) protocol, or other similar protocols (such as TLS), to create a secure logical tunnel for communication between processor 46 and server 24. These protocols provide that all data transmitted between processor 46 and server 24 through the tunnel are securely encrypted. Therefore, once this sort of secure tunnel has been established, processor 46 will be able to automatically generate the desired signatures over keyboard input data and the identification code simply by transmitting the data and code together through the tunnel.

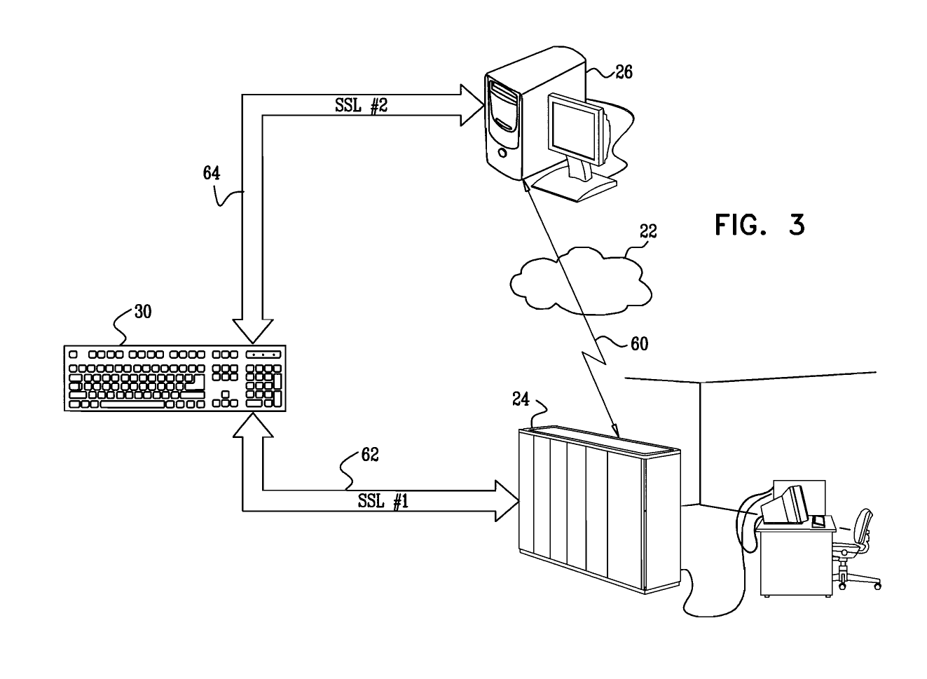

FIG. 3 is a schematic pictorial illustration showing physical and logical communication paths used for secure tunneling between the elements of the system of FIG. 1, in accordance with an embodiment of the present invention. Communications between processor 46 in keyboard 30 and server 24 are carried over a physical communication path 60 between computer console 26 and server 24 via network 22. In order to convey sensitive information over physical path 60 without exposing the information to CPU 40, processor 46 opens a secure logical path 62 directly from keyboard 30 to server 24. Although logical path 62 is carried physically from keyboard 30 to console 26, and through the console over physical path 60 to the server, the information transmitted over the logical path is encrypted by processor 46 in a manner inaccessible to CPU 40. For example, logical path 62 may comprise a SSL connection between keyboard 30 and server 24, which “tunnels” transparently through console 26. The computer console merely relays the packets transmitted over path 62, without being able to read or alter the higher-level protocol headers and payload data in these packets.

In order to permit the user of computer 20 to see information (such as Web pages) on display 28, including information that the user inputs via keyboard 30, processor 46 may open a second logical path 64, which may also be a SSL connection, between keyboard 30 and console 26. Processor 46 then passes information over path 64 for display by computer 20. Thus, keyboard 30 can serve as a sort of SSL proxy between computer 20 and server 24. When keyboard 30 encounters a Web page containing a field for secure data (such as the amount or target account for a transfer of funds), for example, it prompts the user to flip switch 34 so that processor 46 will sign the data with a signature that include the identification code. Alternatively, as noted above, processor 46 may generate such signatures automatically, or it may simply sign all data. Beyond this signature function, Web pages, including secure data, may be displayed and behave in the normal fashion on computer 20.

In addition to these data signature functions, the logical path topology shown in FIG. 3 may also be used to hide certain secret data, such as user passwords and credit card information, from CPU 40 and memory 44, so that they cannot be detected and read out of computer 20 by a Trojan horse or other spyware program. When the user inputs this sort of information via keyboard 30, processor 46 does not echo the data to CPU 40, but rather outputs a dummy string (such as “****”) and sends the secret data only over path 62 to server 24. The CPU may then display the dummy string in the appropriate field on screen 28 to inform the user that the data input has been received. This mode of use of the topology shown in FIG. 3 is described further in the above-mentioned PCT patent application. It may be invoked using a user-operable switch or automatically.

In order to reduce the computational load on processor 46, which might otherwise be a bottleneck in communications between computer 20 and server 24, computer 20 may open a separate socket directly to server 24 (not shown in FIG. 3). This direct socket may then be used, for example, for Web pages that do not contain fields for secure data. In the course of a communication session with computer 20 over this direct socket, server 24 may direct computer 20 to transfer the session to processor 46 before transmitting a page containing a field for secure data. In such a case, computer 20 may pass the session information (such as any relevant cookies) to processor 46. The processor will use the session information in opening new SSL sessions over logical paths 62 and 64 in order to continue the interaction between server 24 and computer 20 while ensuring that the information carried over path 62 will be appropriately secured in a manner that is unintelligible to CPU 40.

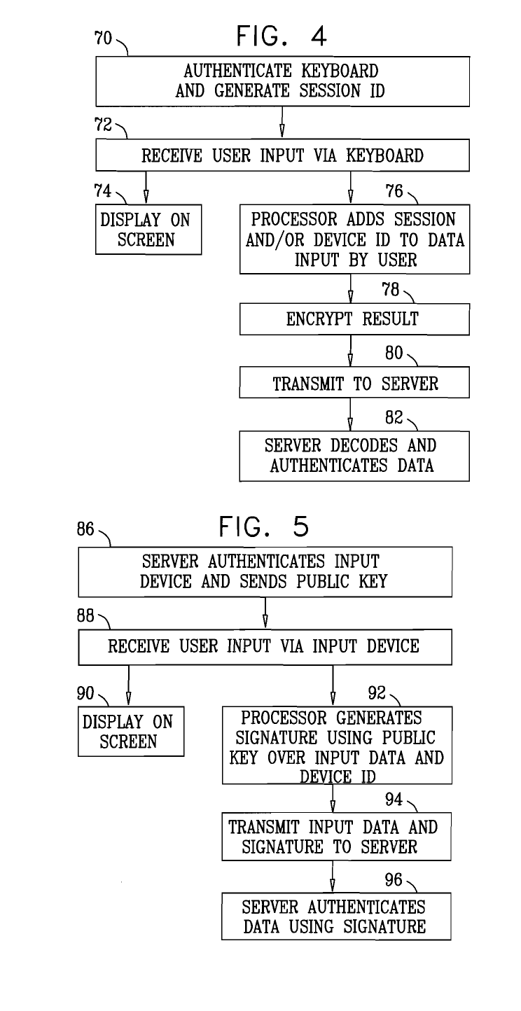

FIG. 4 is a flow chart that schematically illustrates a method for secure communications, in accordance with an embodiment of the present invention. The method is described below, by way of example, with reference to keyboard 30 and the other components of the system shown in the preceding figures. Alternatively, the method may be implemented in substantially any sort of computer system in which secure data are to be authenticated by a remote computer, and using any sort of encryption processor that has the capabilities set forth hereinabove.

Before transmitting secure data to server 24, the user of computer 20 initiates a communication session between the computer and the server. Typically, server 24 prompts the user to input a username and password. As part of the initiation protocol, server 24 also authenticates keyboard 30, at an input device authentication step 70. For example, the server may use a challenge/response procedure to identify the keyboard (based on a hardware code embedded in the keyboard, for example) and to verify that the keyboard is configured to sign the data in the required manner. When the keyboard has been successfully authenticated, a secure logical path, such as path 62, may be established between processor 46 and server 24. Typically, once the user and keyboard have been authenticated and the secure path has been established, the server generates a session identifier (session ID) and transmits the session ID over the secure path to processor 46.

Processor 46 receives data input from the user of computer 20 via keyboard 30, at a user input step 72. The data are displayed on screen 28 so that the user can see and check that the data are correct, at a data display step 74 (with the exception of certain secret data, which are not echoed to the screen and may also be hidden from CPU 40, as noted above). In order to sign the data, processor 46 concatenates either the data or a suitable function of the data with an identification code, at a code addition step 76. For example, the processor may compute a suitable hash function over the data and then concatenate the hash function with the identification code. As noted earlier, the identification code may comprise the session ID or the embedded hardware code of the keyboard, or both.

Processor 46 generates a signature over the data and the identification code by encrypting the concatenated result, at a signature generation step 78. For this purpose, the processor may use a public key provided by server 24 or any other suitable key that is known to the server, such as the SSL encryption key. The processor may compute the signature and then pass the signature to CPU 40 as an encrypted data object for transmission to server 24 along with the data. Alternatively, the processor may compute the signature as an implicit part of an encrypted data stream that passes through console 26 over logical path 62. In this latter case particularly, the signature may actually include the data in encrypted form. In either case, the signature (including the data or along with the data) is transmitted from computer 20 to server 24 via network 22 at a signature transmission step 80.

Server 24 receives the signature, with the data, and decodes the signature, at a signature decryption step 82. Upon decoding the signature, the server extracts the identification code used by processor 46 in generating the signature and is thus able to verify that the data it has received are authentic and have not been tampered with. Upon authenticating the data, the server proceeds with whatever action is next required in the session—for example, completing the transaction requested by the user. On the other hand, if data authentication fails, the server will refuse to proceed with the session and may issue an alert, to the authorized user and/or system manager, for example, that a suspicious event has occurred.

FIG. 5 is a flow chart that schematically illustrates a method for secure communications, in accordance with an alternative embodiment of the present invention. This embodiment operates without reliance on a secure logical path between processor 46 and server 24 but does assume that there is a secret hardware code associated with keyboard 30 that is known to the server but is not accessible to CPU 40. Server 24 authenticates the keyboard on the basis of this hardware code at an input device authentication step 86, in a manner similar to that described above. Upon authenticating the keyboard (and typically authenticating the user operating the keyboard, as well), the server sends a public key to computer 20 for use in subsequent signature generation, and CPU 40 passes this key to processor 46.

In the course of the communication session with server 24, the user of computer 20 inputs data to the computer via keyboard 30, at a data input step 88. The data are input to console 26 in clear form and are displayed on screen 28 at a data display step 90. In the meanwhile, processor 46 intercepts the data and generates a signature over the data together with the keyboard hardware code using the public key transmitted by the server, at a signature generation step 92. As noted earlier, the signature may be computed using the data input itself or using a transformed version of the data, such as a hash function of the data. For enhanced security, processor 46 may incorporate other metadata, such as a timestamp, into the signature computation.

Processor 46 passes the signature that it has generated to CPU 40, which then transmits the signature, together with the data received at step 88, to server 24, at a data transmission step 94. The server decodes the signature using the appropriate private key in order to verify the authenticity of the data, at a data authentication step 96. Equivalently, the server may compute its own expected value of the signature over the received data and the known hardware code of the keyboard, and may match this computed value to the actual signature value that it received at step 94. Based on the results of step 96, the server decides whether to proceed with the current transaction or deny the transaction, as described above.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
initiating a communication session over a network between a remote computer and a local computer, which has a central processing unit (CPU) and an input device;
storing a record at the remote computer of an identification code that is associated with the input device of the local computer and is inaccessible to the CPU;
receiving data input by a user to the local computer via the input device;
generating at the local computer a cryptographic signature over the data and the identification code using a processor other than the CPU;
transmitting the signature to the remote computer; and
decrypting the signature at the remote computer in order to authenticate the data.

2. The method according to claim 1, wherein the input device comprises a keyboard.

3. The method according to claim 2, wherein the keyboard has a housing, and wherein the processor is contained inside the housing of the keyboard.

4. The method according to claim 1, wherein receiving the data comprises displaying the data on an output device associated with the local computer.

5. The method according to claim 4, wherein displaying the data comprises presenting a page provided by the remote computer on the output device, the page comprising a field that is filled in with the data input by the user.

6. The method according to claim 1, wherein the signature transmitted to the remote computer contains the data.

7. The method according to claim 1, and comprising transmitting the data to the remote computer in addition to transmitting the signature.

8. The method according to claim 1, wherein the identification code comprises a hardware code that is embedded in the input device.

9. The method according to claim 8, wherein initiating the communication session comprises creating a session identifier, and wherein generating the cryptographic signature comprises computing the signature over the data, the hardware code and the session identifier.

10. The method according to claim 1, wherein the identification code comprises a session identifier.

11. The method according to claim 1, wherein transmitting the signature comprises conveying the signature from the processor to the remote computer via a tunneled logical path through the local computer.

12. Apparatus for use in a communication session over a network between a remote computer and a local computer, which has a central processing unit (CPU), the apparatus comprising:
an input device comprising an input transducer, for receiving data input by a user to the local computer; and
a processor, which is coupled to the input transducer and is configured to generate, using an identification code that is recorded by the remote computer and is inaccessible to the CPU, a cryptographic signature over the data and the identification code for transmission of the signature to the remote computer, wherein the signature is decryptable by the remote computer in order to authenticate the data.

13. The apparatus according to claim 12, wherein the input device comprises a keyboard.

14. The apparatus according to claim 13, wherein the keyboard has a housing, and wherein the processor is contained inside the housing of the keyboard.

15. The apparatus according to claim 12, wherein the processor is configured to convey the data for display on an output device associated with the local computer.

16. The apparatus according to claim 15, wherein the data are input by the user in order to fill in a field on a page provided by the remote computer and presented by the local computer on the output device.

17. The apparatus according to claim 12, wherein the signature generated by the processor contains the data.

18. The apparatus according to claim 12, wherein the processor is configured to generate the signature over a function of the data, for transmission to the remote computer in addition to transmitting the data.

19. The apparatus according to claim 12, wherein the identification code comprises a hardware code that is embedded in the input device.

20. The apparatus according to claim 19, wherein the processor is configured to compute the cryptographic signature over the data, the hardware code and a session identifier that is associated with the communication session.

21. The apparatus according to claim 12, wherein the identification code comprises a session identifier that is associated with the communication session.

22. The apparatus according to claim 12, wherein the processor is configured to establish a tunneled logical path through the local computer to the remote computer and to convey the signature to the remote computer via the tunneled logical path.
